(19) United States
(12) Patent Application Publication
(10) Pub. No.: US 2025/0365826 A1
(43) Pub. Date: Nov. 27, 2025

(54) DOOR LOCK SYSTEM AND COOKING APPLIANCE HAVING THE SAME

(71) Applicant: SAMSUNG ELECTRONICS CO., LTD., Suwon-si (KR)

(72) Inventors: Sangwon YUN, Suwon-si (KR); Sangbeom KIM, Suwon-si (KR); Seungwoo HAN, Suwon-si (KR)

(73) Assignee: SAMSUNG ELECTRONICS CO., LTD., Suwon-si (KR)

(21) Appl. No.: 19/264,506

(22) Filed: Jul. 9, 2025

Related U.S. Application Data
(63) Continuation of application No. PCT/KR2025/006455, filed on May 13, 2025.

(30) Foreign Application Priority Data
May 21, 2024 (KR) 10-2024-0066053

(51) Int. Cl. H05B 6/64; E05B 47/00; E05B 65/00; F24C 15/02

(52) U.S. Cl. CPC H05B 6/6414; E05B 47/0012; E05B 65/00; F24C 15/022; E05B 2047/0017

(57) ABSTRACT

A cooking appliance may include a cabinet including a cooking chamber and a pressing hole, a door including a latch, the door being moveable between a close position and an open position and including a locking member, wherein the door and the locker are configured so that, in response to the door being moved to the close position, the latch is inserted in the locker, and with the latch inserted in the locker, the locking member is moveable between: a restricting position where the door is fastened to the cabinet in a locked state, and an allowing position where the door is unfastened from the cabinet in an unlocked state, and the pressing hole is configured so that, with the locking member in the restricting position, an external force generated from outside of the cabinet is transferable through the pressing hole to move the locking member to the allowing position.

### CROSS-REFERENCE TO RELATED APPLICATIONS

This is a continuation application, under 35 U.S.C. § 111 (a), of International Application No. PCT/KR2025/006455, filed May 13, 2025, which claims priority under 35 U.S.C. § 119 to Korean Patent Application No. 10-2024-0066053, filed May 21, 2024, in the Korean Intellectual Property Office, the disclosures of which are incorporated herein in their entireties by reference.

### TECHNICAL FIELD

The disclosure relates to a door lock system and cooking appliance including the door lock system, and more particularly, to a door lock system having an enhanced door unlocking mechanism and a cooking appliance including the door lock system.

### BACKGROUND ART

The microwave oven is a kitchen appliance for cooking food by irradiating high-frequency waves to simultaneously heat inside and outside of the food. With the high thermal efficiency, the microwave oven may significantly shorten the cooking time of foods and reduce the loss of nutritional value of the food in the process of cooking, defrosting and reheating the food. Another merit of intactly cooking food that is stored in a container makes it widely used.

The microwave oven is operated by a user who has put an object into the cooking chamber, closed the door of the cooking chamber and set a certain operation time, and during the operation of the microwave oven, the door is locked and cannot be opened arbitrarily, and thus, in a certain situation where the door needs to be forcedly opened, a problem may occur.

### DISCLOSURE

### Technical Problem

The disclosure provides a door lock system arranged for a door to be arbitrarily opened with external force while the door is in a locked state, and a cooking appliance including the door lock system.

The door lock system and cooking appliance including the same according to an embodiment of the disclosure may allow forced opening of the locked door manually and easily.

Technological objectives of the disclosure are not limited to what are mentioned above, and throughout the specification, it will be clearly appreciated by those of ordinary skill in the art that there may be other technological objectives unmentioned.

### Technical Solution

In accordance with the present disclosure, a cooking appliance may include: a cabinet including a cooking chamber and a pressing hole: a door including a latch, the door being moveable between a close position in which the cooking chamber is closed and an open position in which the cooking chamber is opened, and a locker inside the cabinet and including a locking member, wherein the door and the locker are configured so that, in response to the door being moved to the close position, the latch is inserted in the locker, and with the latch inserted in the locker, the locking member is moveable between: a restricting position where the latch is fastened to the locker so that movement of the latch out of the locker is restricted and the door is fastened to the cabinet in a locked state, and an allowing position where the latch is unfastened from the locker so that movement of the latch out of the locker is allowed and the door is unfastened from the cabinet in the unlocked state, and the pressing hole is configured so that, with the locking member in the restricting position, an external force generated from outside of the cabinet is transferable through the pressing hole to the locking member to move the locking member to the allowing position.

With the door in the close position, the latch inserted in the locker, and the locking member in the restricting position, the locking member may be rotatable between the restricting position and the allowing position.

With the door in the close position, the latch inserted in the locker, and the locking member in the restricting position, the locking member may be moveable from the restricting position to the allowing position by the locking member being pressed by an external object inserted in the pressing hole.

The locker may further include: a pressing member, and the locking member and the pressing member may be configured so that, with the door in the close position, the latch inserted in the locker, and the locking member in the restricting position, the external force is transferable by the pressing member to move the locking member from the restricting position to the allowing position.

With the door in the close position, the latch inserted in the locker, and the locking member in the restricting position, the pressing member may be pressable by an external object being inserted in the pressing hole so as to move the pressing member and thereby press the locking member to move the locking member from the restricting position to the allowing position.

The pressing member may be between the pressing hole and the locking member.

The locker may further include a driving motor, and with the door in the close position and the latch inserted in the locker, the driving motor may be configured to rotate the locking member between the restricting position and the allowing position.

The locking member may include: a rotator connected to the driving motor and configured to rotate with rotation of the driving motor, and a fastener extending from the rotator and configured to rotate with rotation of the rotator so that, with the door in the close position and with the latch inserted in the locker, in response to the locking member being rotated to the restricting position by the driving motor, the latch may be fastened to the locker by the fastener.

With the door in the close position, the latch inserted in the locker, and the locking member in the restricting position, the fastener may be adjacent to the latch so that movement of the latch out of the locker is restricted.

With the door in the close position and with the latch inserted in the locker, in response to the locking member being rotated from the restricting position to the allowing position, the fastener may be moved away from the latch so that movement of the latch out of the locker is allowed.

The locker may further include a guide configured so that, in response to the latch being inserted in the locker, and a fixer arranged for the latch to be fixed to the locker, and with the door in the close position, the latch inserted in the locker, and the locking member in the restricting position, the fastener may be above the latch.

The pressing member may be configured to move by rotation to press the locking member.

With the door in the close position, the latch inserted in the locker, and the locking member in the restricting position, the locking member may be rotatable between the restricting position and the allowing position, and the locking member may be rotatable to the allowing position by the locking member being pressed in a pressing direction of the pressing member.

An extending direction of an axis of rotation of the locking member may be parallel to an extending direction of an axis of rotation of the pressing member.

With the door in the close position and the latch inserted in the locker, a direction in which the locking member may be rotated from the restricting position to the allowing position may correspond to a direction in which the locking member may be rotated by the external force transferred through the pressing hole.

### DESCRIPTION OF DRAWINGS

FIG. 1 is a front view of a microwave oven and an enlarged view of a portion thereof, according to an embodiment of the disclosure.

FIG. 2 is an exploded perspective view of the microwave oven shown in FIG. 1.

FIG. 3 illustrates a locker of the microwave oven shown in FIG. 1.

FIG. 4 illustrates a door of the microwave oven shown in FIG. 1 placed in an open position.

FIG. 5 illustrates the door of the microwave oven shown in FIG. 1 placed in a close position and a locking member placed in an allowing position.

FIG. 6 illustrates the locking member of the microwave oven shown in FIG. 1 placed in a restricting position.

FIG. 7 illustrates the locking member of the microwave oven shown in FIG. 1 moved from the restricting position to the allowing position.

FIG. 8 illustrates the door of the microwave oven shown in FIG. 1 moved from the close position to the open position.

FIG. 9 illustrates a pressing member pressed by the user while the locking member of the microwave oven shown in FIG. 1 is placed in the restricting position.

FIG. 10 illustrates the locking member of the microwave oven shown in FIG. 1 moved from the restricting position to the allowing position by being pressed by the pressing member.

FIG. 11 illustrates the locker when the pressure on the locking member of the microwave oven shown in FIG. 1 is released.

FIG. 12 illustrates a locking member of a microwave oven being pressed by the user while being placed in a restricting position, according to an embodiment.

FIG. 13 illustrates the locking member of the microwave oven shown in FIG. 12 moved from the restricting position to an allowing position by being pressed by the user.

### MODES OF THE INVENTION

It is understood that various embodiments of the disclosure and associated terms are not intended to limit technical features herein to particular embodiments, but encompass various changes, equivalents, or substitutions.

Like reference numerals may be used for like or related elements throughout the drawings.

The singular form of a noun corresponding to an item may include one or more items unless the context states otherwise.

Throughout the specification, “A or B”, “at least one of A and B”, “at least one of A or B”, “A, B or C”, “at least one of A, B and C”, and “at least one of A, B, or C” may each include any one or all the possible combinations of A, B and C.

The expression “and/or” is interpreted to include a combination or any of associated elements.

Terms like “first”, “second”, etc., may be simply used to distinguish an element from another, without limiting the elements in a certain sense (e.g., in terms of importance or order).

When an element is mentioned as being “coupled” or “connected” to another element with or without an adverb “functionally” or “operatively”, it means that the element may be connected to the other element directly (e.g., wiredly), wirelessly, or through a third element.

It will be further understood that the terms “comprise” and/or “comprising,” when used in this specification, specify the presence of stated features, integers, steps, operations, elements, parts or combinations thereof, but do not preclude the possible presence or addition of one or more other features, integers, steps, operations, elements, components, and/or groups thereof.

When an element is mentioned as being “connected to”, “coupled to”, “supported on” or “contacting” another element, it includes not only a case that the elements are directly connected to, coupled to, supported on or contact each other but also a case that the elements are connected to, coupled to, supported on or contact each other through a third element.

Throughout the specification, when an element is mentioned as being located “on” another element, it implies not only that the element is abut on the other element but also that a third element exists between the two elements.

Reference will now be made in detail to embodiments, examples of which are illustrated in the accompanying drawings, wherein like reference numerals refer to the like elements throughout.

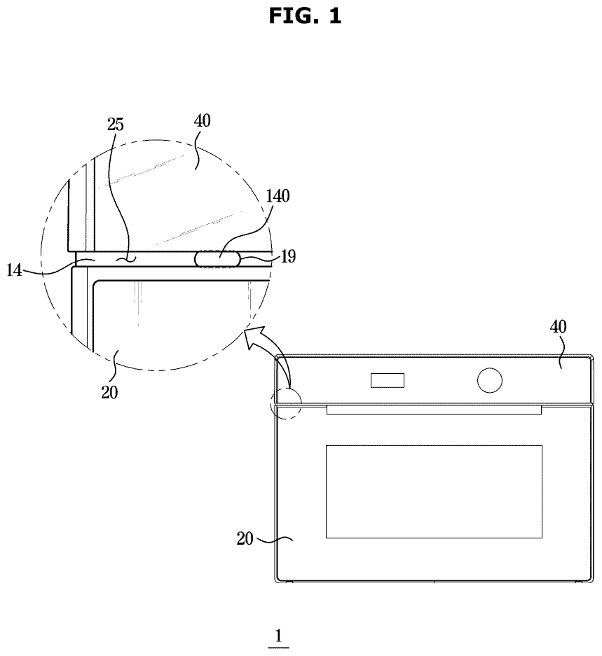

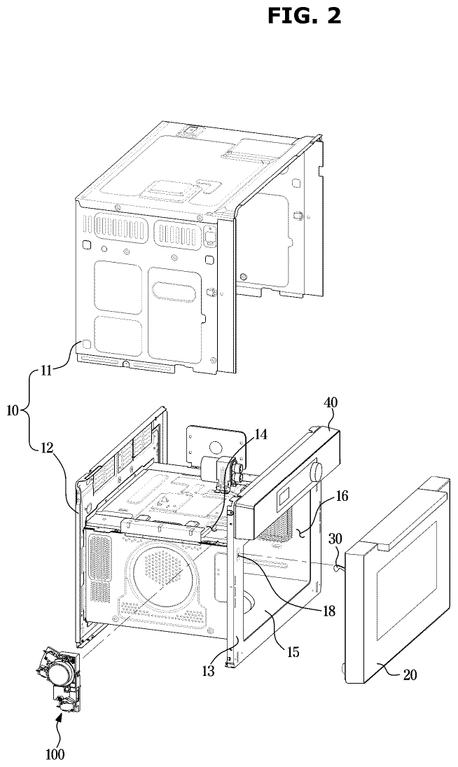

FIG. 1 is a front view of a microwave oven and an enlarged view of a portion thereof, according to an embodiment of the disclosure, and FIG. 2 is an exploded perspective view of the microwave oven shown in FIG. 1.

For example, among cooking appliances, a microwave oven 1 will now be taken as an example, but the disclosure is not limited thereto but may be equally applied to a general cooking appliance having a door that may remain locked by being fixed to a cabinet apart from the microwave oven, and a door lock system including a locker, a door and a cabinet.

Referring to FIGS. 1 and 2, the microwave oven 1 may include a cabinet 10 that defines a cooking chamber 15. The microwave oven 1 may include a door 20 that opens or closes the cooking chamber 15.

The cabinet 10 may be defined as a main body of the microwave oven 1 as well.

The cabinet 10 may include a cabinet cover 11 that defines an exterior of the microwave oven 1. The cabinet cover 11 may be arranged to form the top and both sides of the cabinet 10, but is not limited thereto and may be arranged to additionally form the bottom of the cabinet 10.

It is not limited thereto, and when the microwave oven 1 is installed in a built-in type, one of the top, both sides and the bottom of the cabinet 10 may not be formed by the cabinet cover 11.

The cabinet 10 may include a cabinet frame 12 formed within the cabinet cover 11 to form the cooking chamber 15.

The cabinet frame 12 may form an interior frame of the cabinet 10.

The cabinet frame 12 may form a cabinet interior space 14 in the cabinet 10 together with the cabinet cover 11.

An opening 16 may be formed on the front of the cabinet frame 12, and the cooking chamber 15 may be arranged inside the cabinet frame 12 from the opening 16.

The cabinet frame 12 may include a front plate 13 that forms the front side of the cabinet 10. The front plate 13 may be arranged to extend outward along the edges of the opening 16. Alternatively, the front plate 13 may be described as a component that forms the opening 16.

There may be a pressing hole 19 arranged on the front plate 13 to be connected to the cabinet interior space 14 and arranged to press a pressing member 140 of a locker 100, which will be described later, from outside.

The pressing hole 19 may be formed in a certain size to allow the user to press the pressing member 140 with a tool by pushing the tool through the pressing hole 19.

The pressing member 140 may be exposed by the pressing hole 19 to the outside.

It is not, however, limited thereto, and the locker 100 may not include the pressing member 140, in which case, the user may push the tool through the pressing hole 19 to press a locking member 120, which will be described later. In this case, the locking member 120 may be exposed by the pressing hole 19 to the outside.

The front surface of the front plate 13 may be coupled to a control panel 40 to select a microwave intensity or operation time depending on an amount of a cooking item. The front plate 13 may be arranged to form a front exterior of the microwave oven 1.

For example, the control panel 40 may be placed above the door 20 to be exposed to the outside even when the door 20 is closed. It is not, however, limited thereto, and the control panel 40 may be placed on a side of or under the door 20, and at least a portion of the control panel 40 may be hidden when the door 20 is closed.

For example, the control panel 40 may be provided as a touch screen. For example, the control panel 40 may be placed on the door 20, moved along with the door 20 and may form at least a portion of the exterior of the door 20.

The pressing hole 19 may be located in a space 25 between the control panel 40 and the door 20. The pressing hole 19 is a component to press the locker 100, which will be described later, to arbitrarily open the door 20 when the door 20 is in a close position 20B, and may be located to be exposed to the outside when the door 20 is in the close position 20B.

The door 20 may be arranged to open or close the opening 16 of the cabinet 10. The door 20 may be arranged to open or close the cooking chamber 15.

The door 20 may be provided to form a front exterior of the microwave oven 1.

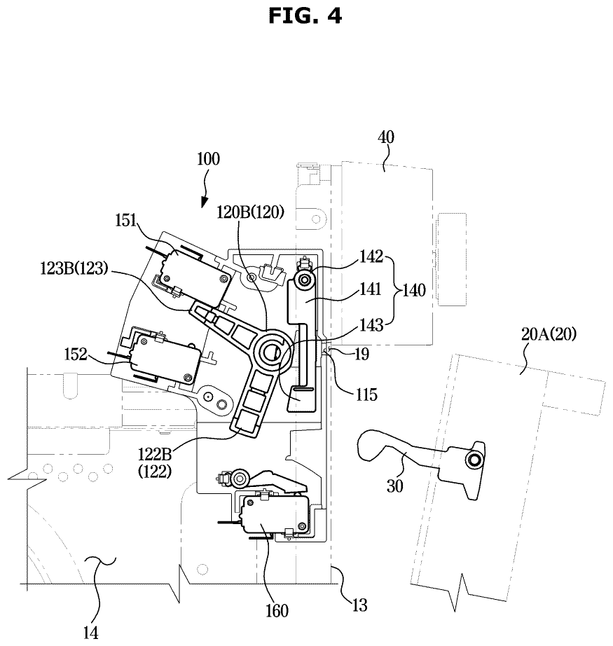

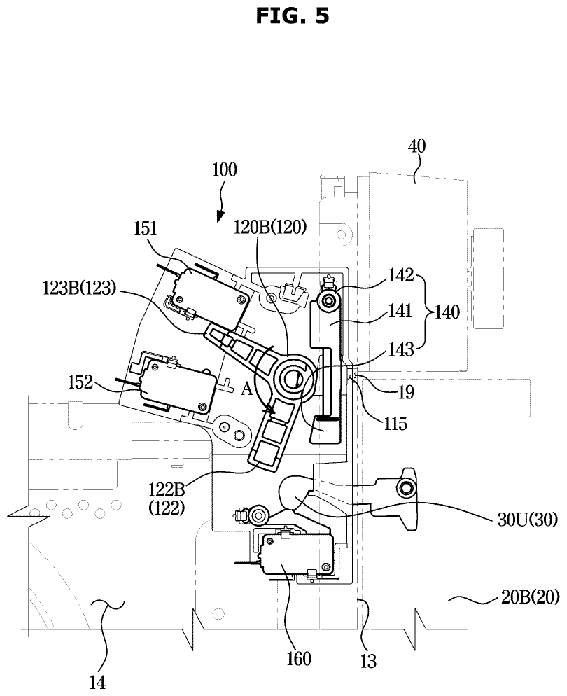

The door 20 may be arranged to be movable between an open position 20A in which the cooking chamber 15 is opened and the close position 20B at which the cooking chamber 15 is closed. For example, the door 20 may be arranged to be rotated between the open position 20A and the close position 20B (see FIGS. 4 and 5).

The open position 20A may be defined as a position 20A to put the cooking chamber 15 in an open state to the outside. In other words, the open position 20A may be defined as a position other than the close position 20B, in which the door 20 is opened.

The close position 20B may be defined as a position of the door 20 in which the door 20 closes the cooking chamber 15 to shield the cooking chamber 15 from the outside.

The close position 20B may be defined as a position in which a latch 30, which will be described later, is inserted to the locker 100 to fix the door 20 to the cabinet 10.

When the door 20 is located in the close position 20B, the door 20 may be in a locked state in which the user is unable to move the door 20 from the close position 20B to the open state 20A or in an unlocked state in which the user is able to arbitrarily move the door 20 from the close position 20B to the open position 20A.

The locked state of the door 20 may be defined as a state in which the door 20 remains in the close position 20B even when the user presses the door 20 in the locked state of the door 20.

The unlocked state of the door 20 may be defined as a state in which the door 20 is movable from the close position 20B to the open position 20A when the user presses the door 20 when the door 20 is in the unlocked state.

The door 20 may include the latch 30 that fixes the door 20 to the cabinet 10 to maintain the door 20 in the close position 20B when the door 20 is in the close position 20B.

The latch 30 may be arranged to be inserted to the locker 100, which will be described later, to fix the door 20 to the cabinet 10. When the door 20 is in a locked state, the latch 30 is arranged not to fall out of the locker 100, and when the door 20 is in an unlocked state, the latch 30 may be arranged to fall out of the locker 100 and the door 20 may be separated from the cabinet 10.

The latch 30 may be placed on the rear surface of the door 20. The latch 30 may be arranged to protrude from the rear surface of the door 20 toward the cabinet 10. The latch 30 may be elastically moved by an elastic member.

An electric room having various electric parts mounted therein may be formed in at least a portion of the cabinet interior space 14.

The microwave oven 1 may include the locker 100 placed in the cabinet interior space 14 to fix the door 20 when the door 20 is located in the close position 20B.

The locker 100 may be arranged to put the door 20 in the locked state when the door 20 is in the close position 20B.

The locker 100 may be arranged to put the door 20 in the locked state by restricting movement of the latch 30 to restrain the latch 30 from falling out of the locker 100. The door 20 may remain in the close position 20B even when the user presses the door 20 in the locked state.

The locker 100 may be arranged to put the door 20 in the unlocked state by releasing the restriction on the movement of the latch 30 to fall out of the locker 100. The door 20 may be moved from the close position 20B to the open position 20A when the user presses the door 20 in the unlocked state.

The microwave oven 1 may be configured to put the door 20, which is in the close position 20B, in the locked state or unlocked state selectively through the locker 100.

The locker 100 will now be described in detail.

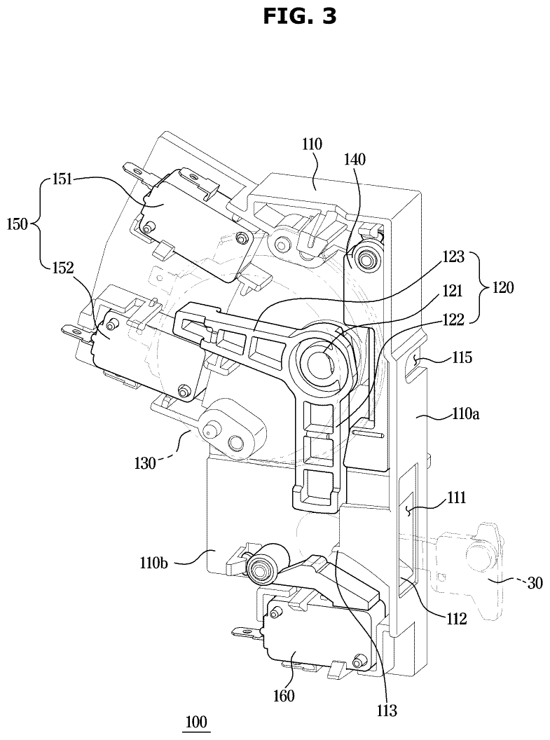

FIG. 3 illustrates a locker of the microwave oven shown in FIG. 1, and FIG. 4 illustrates a door of the microwave oven shown in FIG. 1 placed in an open position.

The locker 100 may include a locker housing 110 that includes an insertion hole 111 to which the latch 30 is inserted.

The locker housing 110 may be arranged to support the locking member 120, a driving motor 130, the pressing member 140 and various switches 150 and 160, which will be described later.

The locker housing 110 may include a guide 112 that guides the latch 30 when the latch 30 is inserted to the insertion hole 111.

The guide 112 may be arranged on the inner side of the insertion hole 111. The guide 112 may be inclined upward toward the inside of the cabinet 10 from the front plate 13.

The latch 30 may be inserted to the insertion hole 111 along the guide 112 that guides the latch 30 upward toward the inside of the cabinet 10 from the front plate 13.

The locker housing 110 may include a fixer 113 placed at an end of the guide 112 in a direction toward the inside of the cabinet 10 from the front plate 13 and arranged to fix the latch 30 inserted to the insertion hole 111.

The fixer 113 may be arranged in a shape that protrudes from the end of the guide 112 in a direction toward the inside of the cabinet 10 from the front plate 13.

The latch 30 may be moved up at an angle by the guide 112. When arriving at the end of the guide 112 in the heading direction of latch 30, the latch 30 may fall down and be caught by a protruding portion of the fixer 113.

When there is no external force to move the door 20 into the open position 20A, the latch 30 may remain caught by the fixer 113 so that the door 20 may remain fixed to the cabinet 20.

On the other hand, when external force is applied to the door 20 to move the door 20 into the open position 20A, the latch 30 may fall out of the fixer 113 and move down at an angle along the guide 112, thereby getting out of the insertion hole 111.

As such, a state of the door 20 in which the latch 30 is fixed by the fixer 113 but is possible to arbitrarily fall out of the fixer 113 by external force may be defined as a fixed state. The fixed state may be defined as an openable state as well.

The fixed state of the door 20 may be a state in which the latch 30 is temporarily fixed to the fixer 113. The latch 30 may be arranged to remain fixed to the fixer 113 while in the fixed state of the door 20, but arranged to be able to fall out of the fixer 113 when external force is applied to the door 20. The fixed state of the door 20 may also be defined as a fixed state of the latch 30 in which the latch 30 may be temporarily fixed to the fixer 113.

The fixed state of the latch 30 may also be defined as an unlocked state 30U of the latch 30 as the latch 30 is fixed to the locker 100 but not locked (see FIG. 5).

The locker housing 110 may include a front portion 110a in which the insertion hole 111, the guide 112 and the fixer 113 are formed, and a side portion 110b arranged to be perpendicular to the front portion 110a and coupled to the locking member 120, the driving motor 130, the pressing member 140 and the various switches 150 and 160.

The front portion 110a may be arranged in the form of a plate facing the door 20. The side portion 110a may have a form that orthogonally extends from a side of the front portion 110a.

It is not, however, limited thereto, and at least one of the locking member 120, the driving motor 130, the pressing member 140 and the various switches 150 and 160 may be coupled to the front portion 110a.

However, it is not limited thereto, and the locker housing 110 may not include the front portion 110a as a component, and the guide 112 and the fixer 113 may be arranged in the side portion 110b. In this case, without the insertion hole 111, the latch 30 may be directly moved toward the guide 112 and fixed to the fixer 113 through the guide 112.

The front portion 110a may include a cutting portion 115 arranged at a corresponding position to the pressing hole 19. The cutting portion 115 may be formed by cutting at least a portion of a hole form or the locker housing 110 so that the pressing member 140, which will be described later, is exposed to the outside of the cabinet 10 through the pressing hole 19.

It is not, however, limited thereto, and when the locker housing 110 does not include the front portion 110a, the pressing member 140 may be arranged to be directly exposed to the outside through the pressing hole 19.

The locker 100 may include the locking member 120 arranged to move between a restricting position 120A at which to restrict movement of the latch 30 so that the latch 30 inserted to the insertion hole 111 is fastened in the locker 100 and an allowing position 120B at which to allow the movement of the latch 30 to unfasten the latch 30.

The locking member 120 may be arranged to rotate between the restricting position 120A and the allowing position 120B.

The locker 100 may include the driving motor 130 to rotate the locking member 120.

The locking member 120 may include a rotator 121 coupled to the shaft of the driving motor 130 to receive rotational power of the driving motor 130, and fastener 122 extending from the rotator 121 in the radial direction of the rotation axis of the rotator 121 and arranged to selectively fasten the latch 30 to the fixer 113 by rotation of the locking member 120.

The fastener 122 may be arranged to fasten the latch 30 to the fixer 113 by restricting movement of the latch 30 in order to prevent the latch 30 from falling out of the fixer 113 even by external force when the locking member 120 is in the restricting position 120A.

When the locking member 120 is placed in the restricting position 120A, the fastener 122 may be placed in a first position 122A in which the fastener 122 is placed adjacent to the top of the latch 30.

The latch 30 may be arranged to be pulled out into the insertion hole 111 along the guide 112 when the latch 30 deviates from the state of being fixed to the fixer 113, and as the latch 30 falls down from the guide 112 and is caught by the fixer 113, the latch 30 needs to be lifted from the fixer 113 and move to the guide 112 to fall out of the fixer 113.

In this case, when the fastener 122 is placed in the first position 122A, the fastener 122 is located adjacent to the top of the latch 30, restricting the latch 30 from moving to the guide 112 from the fixer 113, and accordingly, the fastener 122 may fasten the latch 30 to the fixer 113.

The state in which the latch 30 is fastened to the fixer 113 by the fastener 122 and the latch 30 is prevented from falling out of the fixer 113 even when the door 20 is pressed may be defined as the locked state 30L of the latch 30.

When the latch 30 is in the locked state 30L, the door 20 may be fastened to the cabinet 10 even when external force is applied to the door 20 in the close position 20B. The user is unable to move the door 20 into the open position 20A even by pressing the door 20 while the latch 30 remains in the locked state 30L.

As the locking member 120 is rotated from the restricting position 120A to the allowing position 120B, the fastener 122 may be moved into a second position 122B where the fastener 122 is placed farther away from the top of the latch 30. The second position 122B may be defined as a position in which the fastener 122 does not restrict the movement of the latch 30, and which is engaged with the rotation of the rotator 121 and moved from above the latch 30 in the rotational direction of the rotator 121.

As the fastener 122 is placed in the second position 122B, there is nothing placed above the latch 30 to restrict the movement of the latch 30 so that the latch 30 may be allowed to move from the fixer 113 to the guide 112.

When the locking member 120 is placed in the restricting position 120A, the latch 30 is fastened to the fixer 113 by the fastener 122, but when the locking member 120 is placed in the allowing position 120B and the door 20 is pressed, the latch 30 falls out of the fixer 113 and is pulled out of the insertion hole 111 through the guide 112, and accordingly, the door 20 may be separated from the cabinet 10.

The locking member 120 may include a contactor 123 extending in a different direction from the fixer 122 and arranged to come into contact with a locking member sensor 150, which will be described later.

The contactor 123 may extend from the rotator 121 in the radial direction and may be spaced apart from the fixer 122 in the rotational direction of the rotation axis of the rotator 121.

The contactor 123 may be engaged with the rotator 121 to be rotated. When the locking member 120 is placed in the restricting position 120A, the contactor 123 may be placed in a first position 123A at which the contactor is able to press a first locking member switch 152.

When the locking member 120 is placed in the allowing position 120B, the contactor 123 may be placed in a second position 123B at which the contactor 123 is able to press a second locking member switch 151.

The contactor 123 is arranged to rotate between the first position 123A and the second position 123B to come into contact with the first locking member switch 152 or the second locking member 151.

The locker 100 may include the locking member switch 150 for detecting which one of the restricting position 120A or the allowing position 120B the locking member 120 is located in.

The locking member switch 150 may include the first locking member switch 152 for detecting placement of the locking member 120 in the restricting position 120A and the second locking member switch 151 for detecting placement of the locking member 120 in the allowing position 120B.

The first locking member switch 152 and the second locking member switch 151 may be spaced apart in the rotational direction of the locking member 120.

The contactor 123 may be placed between the first locking member switch 152 and the second locking member switch 151 in the rotational direction of the locking member 120.

The contactor 123 may be rotated between the first locking member switch 152 and the second locking member switch 151, and may come into contact with the first locking member switch 152 to turn on the first locking member switch 152 when the contactor 123 is placed in the first position 123A. In this case, the second locking member switch 151 and the contactor 123 are not in contact with each other, so the second locking member switch 151 may be in the off state.

When the contactor 123 is rotated from the first position 123A to the second position 123B, the first locking member switch 152 may be turned off and the second locking member switch 151 may be turned on by contacting with the contactor 123.

The locker 100 may include a latch switch 160 for detecting whether the latch 30 is fixed to the fixer 113.

The latch switch 160 may be arranged under the fixer 113 and arranged to come into contact with the latch 30 when the latch 30 is caught by the fixer 113.

When the latch 30 is fixed to the fixer 113, the latch 30 may contact and turn on the latch switch 160. Afterwards, when the latch 30 falls out of the fixer 113 and is pulled out of the locker 100, the latch switch 160 may be back into the off state.

The locker 100 may include the pressing member 140 that arbitrarily presses and moves the locking member 120 located in the restricting position 120A into the allowing position 120B.

The pressing member 140 may be arranged to press the locking member 120 in a direction of being pressed by external force transmitted through the pressing hole 19.

For example, the pressing member 140 may be arranged to press the locking member 120 by being rotationally moved by external force transmitted through the pressing hole 19.

The direction in which the pressing member 140 is moved may correspond to the direction in which the locking member 120 is moved from the restricting position 120A to the allowing position 120B. Accordingly, when the pressing member 140 presses the locking member 120, the locking member 120 may be moved from the restricting position 120A to the allowing position 120B according to the pressure of the pressing member 140.

The pressing member 140 may include a body 141, a rotation shaft 142 arranged at one end of the body 141, and a pressing portion 143 arranged at the other end of the body 141 to directly press the locking member 120.

The external force transmitted through the pressing hole 19 may press the body 141 so that the body 141 may be rotated around the rotation shaft 142. In this case, the pressing portion 143 may be engaged with the body 141 and rotated around the rotation shaft 142, pressing the fastener 122 to move the locking member 120.

As for the body 141, the pressing portion 143 may be arranged to protrude in a direction opposite the direction in which the pressing hole 19 is arranged. Hence, when the external force is applied through the pressing hole 19, the pressing portion 143 may be arranged to protrude in a direction corresponding to a pressing direction of the external force.

The extending direction of the rotation axis of the rotator 121 of the locking member 120 may be parallel to the extending direction of the rotation shaft 142 of the pressing member 140.

The locking member 120 and the pressing member 140 may be rotated while sharing an overlapping plane. It is because the pressing member 140 is rotated and presses the locking member 120 in the rotating direction, and the locking member 120 is rotated in the pressing direction.

As the extending direction of the rotation axis of the rotator 121 of the locking member 120 corresponds to the extending direction of the rotation shaft 141 of the pressing member 140, the entire area of the locker 100 may be minimized, so that layout efficiency in the cabinet interior space 14 may increase.

It is not, however, limited thereto, and the locker 100 may not include the pressing member 140. In this case, the locking member 120 may be exposed to the outside through the pressing hole 19, and the user may directly press the locking member 120 to move the locking member 120 into the allowing position 120B.

In other words, the user may move the locking member 120 from the restricting position 120A to the allowing position 120B by directly pressing the locking member 120 placed in the restricting position 120A by penetrating the pressing hole 19 with a tool.

When the door 20 is placed in the open position 20A, the locking member 120 may be placed in the allowing position 120B. It is because movement of the latch 30 is restricted when the latch 30 is inserted to the insertion hole 111 and moved to the fixer 113.

In this case, the contactor 123 may be placed in the second position 123B to come into contact the second locking member switch 151.

Specifically, the locker 100 may be arranged for the locking member 120 to be placed in the allowing position 120B in a normal state, and may be arranged for the locking member 120 to be moved from the allowing position 120B to the restricting position 120A through the driving motor 130 only when the door 20 needs to be locked.

When a cooking item is being cooked or when there is a signal from the user, the locker 100 may be arranged for the locking member 120 to be moved from the allowing position 120B to the restricting position 120A through the driving motor 130.

It is not, however, limited thereto, and the locking member 120 may be placed in the restricting position 120A, and when the latch 30 is inserted to the insertion hole 111 and moved along the guide 112, the latch 30 may be moved to the fixer 113 while pressing and moving the locking member 120 from the restricting position 120A to the allowing position 120B.

The locker 100, the cabinet 10 and the door 20 may be called a door lock system. The door lock system may be applied not only to the aforementioned microwave oven but also to any electronic device or object including a cabinet, a door and the locker, which may be selectively locked or unlocked while the door is in the closed state and may be arbitrarily unlocked from the locked state by a pressing member.

Operation of the locker 100 will now be described in detail.

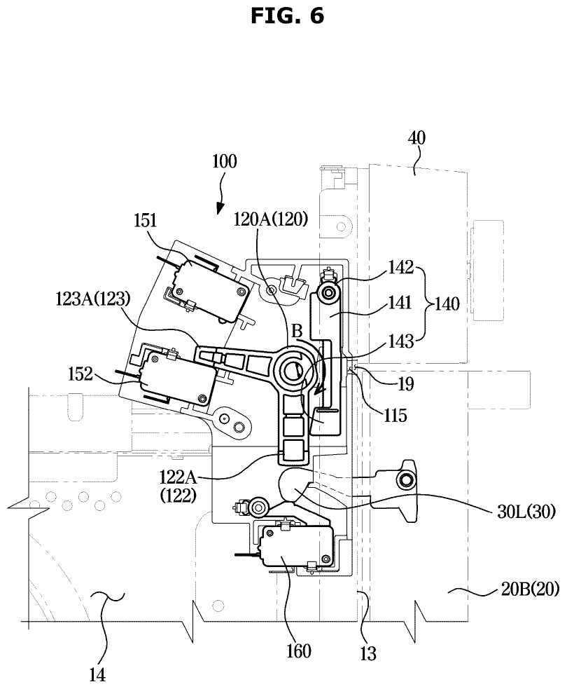

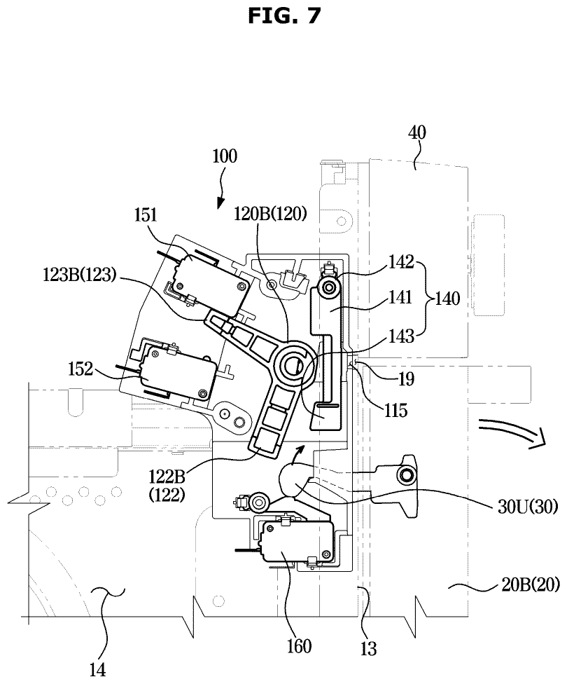

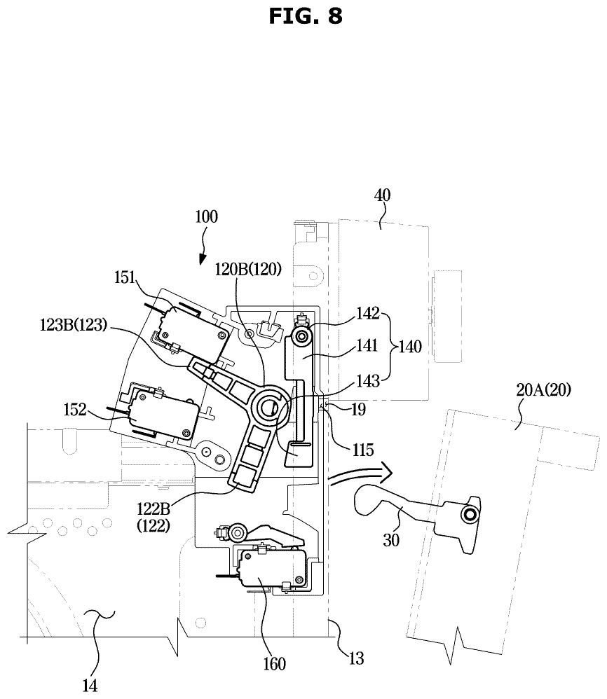

FIG. 5 illustrates the door of the microwave oven shown in FIG. 1 placed in a close position and a locking member placed in an allowing position, FIG. 6 illustrates the locking member of the microwave oven shown in FIG. 1 placed in a restricting position, FIG. 7 illustrates the locking member of the microwave oven shown in FIG. 1 moved from the restricting position to the allowing position, and FIG. 8 illustrates the door of the microwave oven shown in FIG. 1 moved from the close position to the open position.

As shown in FIG. 5, when the door 20 is placed in the close position 20B by the user pressing the door 20, the latch 30 may be inserted to the locker 100.

The latch 30 may be inserted to the locker 100 and fixed to the fixer 113, and when the latch 30 is inserted to the insertion hole 111, the locking member 120 is placed in the allowing position 120B so that the latch 30 may remain in the unlocked state 30U.

As the latch 30 is fixed to the fixer 113, the latch switch 160 may be turned on, and based on a signal generated from the latch switch 160, information indicating that the door 20 is placed in the close position 20B may be displayed on the control panel 40.

Furthermore, as the contactor 123 is placed in the second position 123B, the second locking member switch 151 may be turned on, and based on a signal generated from the second locking member switch 151, information indicating that the latch 30 is in the unlocked state 30U or the door 20 is in an openable state may be displayed on the control panel 40.

Afterwards, when cooking is started or a locking signal of the door 20 is input from the user, the driving motor 130 may be rotated in a first direction A so that the locking member 120 placed in the allowing position 120B may be rotated to the restricting position 120A.

As shown in FIG. 6, when the locking member 120 is placed in the restricting position 120A, the fastener 122 may be placed in the first position 122A and placed adjacent to the top of the latch 30.

Hence, the locking member 120 may restrict the upward movement of the latch 30 to fasten the latch 30 to the fixer 113. Accordingly, the latch 30 may be put in the locked state 30L.

In this case, the contactor 123 is moved from the second position 123B to the first position 123A, the first locking member switch 152 may be turned on, and based on a signal generated from the first locking member switch 152, information indicating that the latch 30 is in the locked state 30L or the door 20 is in a non-openable state may be displayed on the control panel 40.

As the latch 30 is fastened to the fixer 113, the latch switch 160 may continue to be in the on state, and information indicating that the door 20 remains in the closed state 20B may be displayed on the control panel 40.

Afterwards, when the cooking is finished or when the user inputs a signal to unlock, the driving motor may be rotated in an opposite direction B to the first direction A, rotating the locking member 120 from the restricting position 120A to the allowing position 120B.

As shown in FIGS. 7 and 8, as the locking member 120 is placed back in the allowing position 120B, the latch 30 may be changed from the locked state 30L to the unlocked state 30U.

Even in this state, the latch 30 is kept fixed to the fixer 113, the latch switch 160 may remain in the on state, and based on a signal generated from the latch switch 160, information indicating that the door 20 is placed in the close position 20B may be displayed on the control panel 40.

Furthermore, as the contactor 123 is placed back in the second position 123B from the first position 123A, the first locking member switch 152 may be turned off and the second locking member switch 151 may be turned on, and based on signals generated from the first and second locking member switches 152 and 151, information indicating that the latch 30 is in the unlocked state 30U or the door 20 is in an openable state may be displayed on the control panel 40.

Afterwards, when the user presses the door 20 to be in the open state 20A, the latch 30 is able to move into the unlocked state 30U and move up out of the fixer 113.

The latch 30 that falls out of the fixer 113 may be moved along the guide 112 and pulled out of the insertion hole 111, and accordingly, the door 20 may be put into the open state 20A.

Features of arbitrarily changing the state of the locking member 120 by the pressing member 140 will now be described in detail.

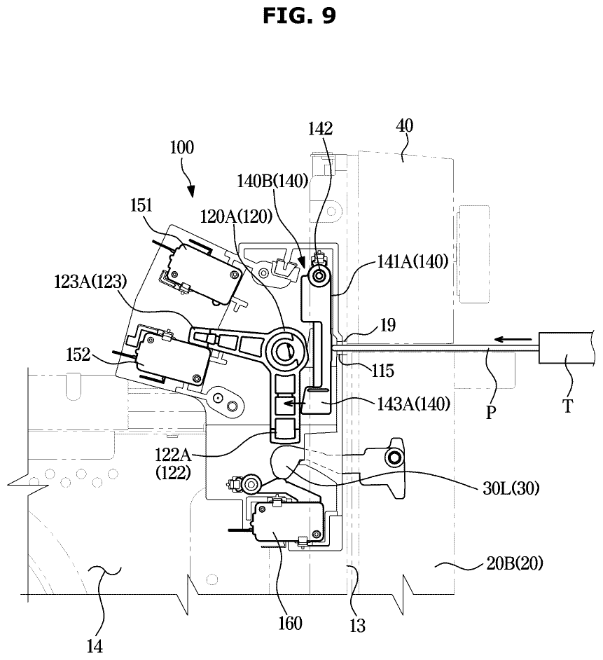

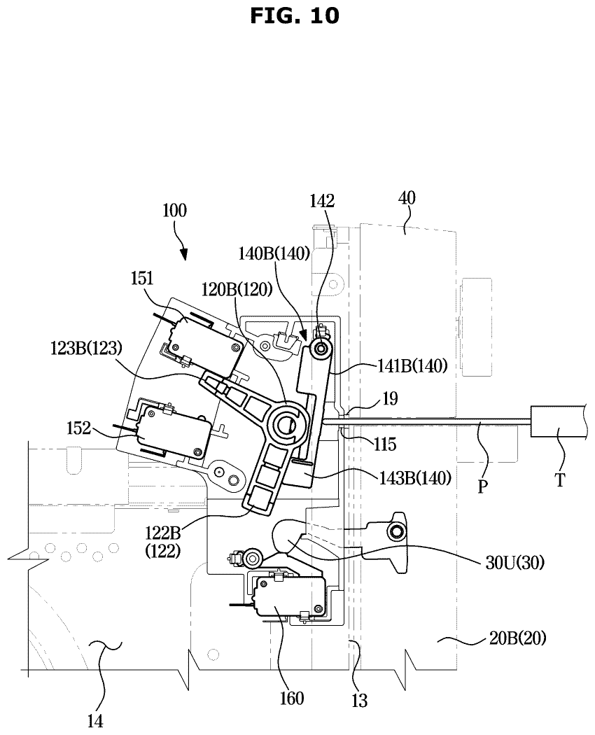

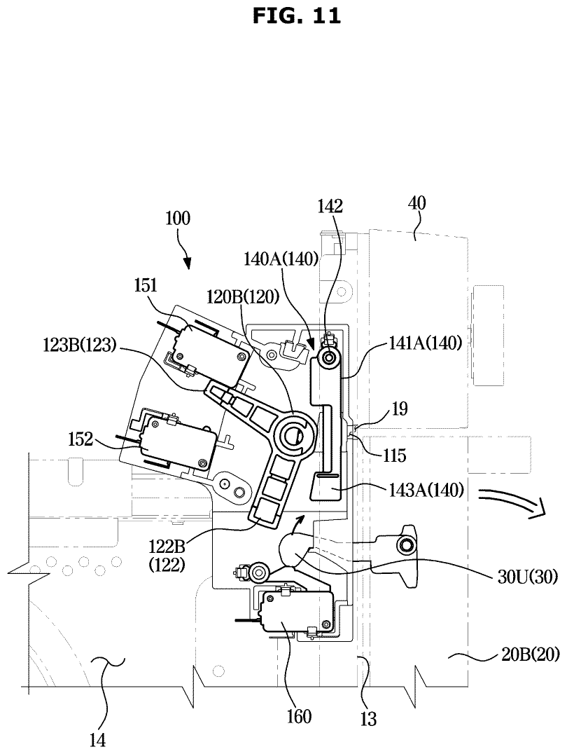

FIG. 9 illustrates a pressing member pressed by the user while the locking member of the microwave oven shown in FIG. 1 is placed in the restricting position, FIG. 10 illustrates the locking member of the microwave oven shown in FIG. 1 moved from the restricted position to the allowing position by being pressed by the pressing member, and FIG. 11 illustrates the locker when the pressure on the locking member of the microwave oven shown in FIG. 1 is released.

As described above, when the latch 30 is put into the locked state 30L and thus, the door 20 is locked, the door 20 is fastened to the cabinet 10 and not opened even when the user presses the door 20.

In the meantime, when the inside of the cooking chamber catches on fire or a similar event occurs, the door 20 may need to be mandatorily opened by arbitrarily unlocking the door 20 even when the door 20 is in the locked state.

The locking member 120 may be rotated by driving the driving motor 130, but when an electric part of the microwave oven 1 is damaged due to an error of the microwave oven 1 or the driving motor 130 itself is damaged, it might be impossible to move the locking member 120 from the restricting position 120A to the allowing position 120B.

To mandatorily open the door 20 even in a similar situation, the locker 100 according to an embodiment of the disclosure may include the pressing member 140 for moving the locking member 120 from the restricting position 120A to the allowing position 120B by arbitrarily pressing the locking member 120, and the pressing hole 19 through which to press the pressing member 140 from outside of the cabinet 10.

As shown in FIG. 9, the user may press the pressing member 140 by using a tool T through the pressing hole 19. It is desirable that the tool T includes a pressing projection P having a cross-sectional area allowed to pass through the pressing hole 19.

The pressing projection P of the tool T may pass a gap 25 between the door 20 and the control panel 40 and pass through the pressing hole 19.

After passing through the pressing hole 19, the pressing projection P may press the pressing member 140 through the cutting portion 115 of the locker housing 110. It is not, however, limited thereto, and the pressing projection P may directly press the pressing hole 19 without passing through the cutting portion 115 of the locker housing 110.

The pressing projection P may be formed to have the height of a cross-sectional area equal to or less than the gap 25 between the control panel 40 and the door 20 to pass through the gap 25 between the control panel 40 and the door 20.

The pressing member 140 may be normally placed in a non-pressing position 140A. The non-pressing position 140A is a position in which the locking member 120 is not pressed, and the body 141 and the pressing portion 143 may also be placed in non-pressing positions 141A and 143A where the locking position 120 is not pressed.

The rotation shaft 142 of the pressing member 140 may be arranged at the top of the body, and may be rotationally fixed to the locker housing 110. The body 141 may be located down from the rotation shaft 142 by gravity.

As the locking member 120 is placed in the restricting position 120A and thus, the latch 30 remains in the locked state 30L, the door 20 is unable to move into the open position 20A. In this case, the user may put the door 20 into the openable state from the non-openable state by using the tool T to forcedly move the locking member 120 into the allowing position 120B.

The pressing projection P may press a portion of the body 141 of the pressing member 140 through the pressing hole 19, the portion being exposed to the outside through the pressing hole 19.

The body 141 pressed by the pressing projection P may be rotated around the rotation shaft 142 in a direction in which the pressing projection P is pressed. Accordingly, the pressing portion 143 may be moved from the non-pressing position 143A in a direction corresponding to the pressing direction of the pressing projection P to press the locking member 120.

As shown in FIG. 10, the pressing member 140 may be rotated by external pressure from the non-pressing position 140A to the pressing position 140B in which the locking member 120 is pressed.

The pressing portion 143 may be rotated and moved to the pressing position 143B from the non-pressing position 143A. The pressing position 143B may be defined as a position in which the pressing portion 143 presses the locking member 120 to move the locking member 120 to the allowing position 120B from the restricting position 120A.

The pressing projection P may press the body 141 so that the pressing portion 143 is moved to the pressing position 143B. Accordingly, the body 141 placed in the non-pressing position 141A may be moved into the pressing position 141B so as for the body 141 to arrive at the pressing position 143B where the pressing portion 143 is able to press the locking member 120 through the pressing projection P.

As shown in FIG. 11, after the pressure of the pressing projection P is released, the pressing member 140 may be rotated back into the non-pressing position 140A from the pressing position 140B by gravity.

As the locking member 120 is moved into the allowing position 120B from the restricting position 120A by the pressing member 140, the latch 30 may be put in the unlocked state 30U, and accordingly, the door 20 may be put in a state of being arbitrarily openable from the close position 20B.

Specifically, the microwave oven 1 in the disclosure may allow the user to easily put the door that is kept locked into an openable state by changing the state of the locker 100 by means of the pressing hole 19 and the pressing member 140 simply through the tool T from outside.

It is not, however, limited thereto, and the locker 100 may not include the pressing member 140 but with the pressing projection P inserted to the pressing hole 19 to directly press the locking member 120, may enable the locking member 120 to be moved to the allowing position 120B from the restricting position 120A.

A locker 100′ of the microwave oven 1 will now be described according to an embodiment. Other features than a feature of the locker 100′ as will be described below are the same as those of microwave oven 1 as described above, so the description thereof will not be repeated.

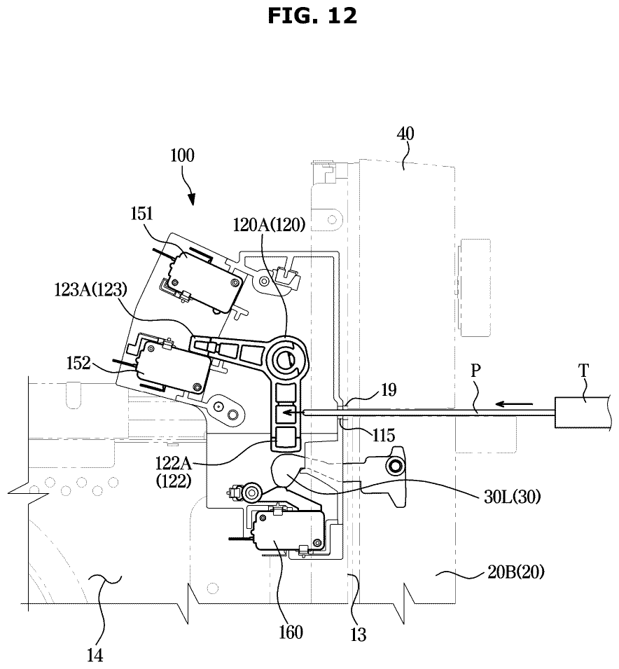

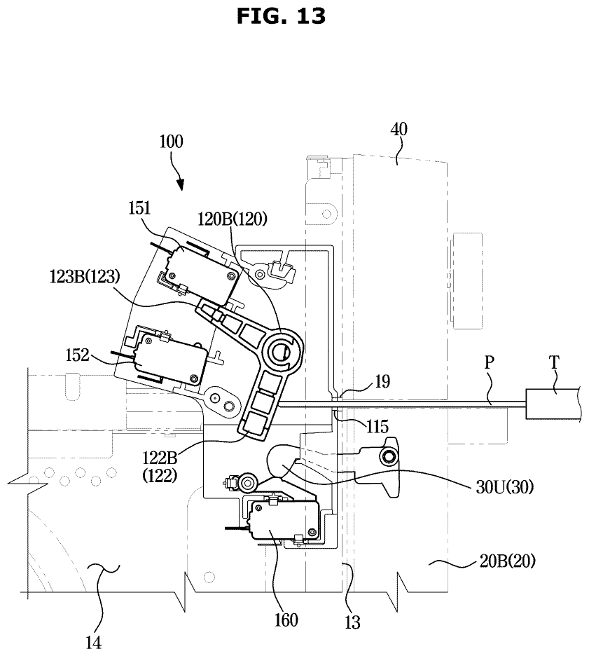

FIG. 12 illustrates a locking member of a microwave oven being pressed by the user while being placed in a restricting position, according to an embodiment, and FIG. 13 illustrates the locking member of the microwave oven shown in FIG. 12 moved from the restricting position to an allowing position by being pressed by the user.

As shown in FIGS. 12 and 13, the locker 100′ may not include the aforementioned pressing member, and may be arranged for the tool T to directly press the locking member 120 through the pressing hole 19.

The user may press the locking member 120 by using the tool T through the pressing hole 19.

The gap 25 between the door 20 and the control panel 40 may be arranged substantially at the height corresponding to the fastener 122 of the locking member 120.

After passing through the pressing hole 19, the pressing projection P may press the fastener 122 of the locking member 120 through the cutting portion 115 of the locker housing 110. It is not, however, limited thereto, and the pressing projection P may directly press the pressing hole 19 without passing through the cutting portion 115 of the locker housing 110.

As the locking member 120 is placed in the restricting position 120A and thus, the latch 30 remains in the locked state 30L, the door 20 is unable to move into the open position 20A. In this case, the user may put the door 20 into the openable state from the non-openable state by using the tool T to forcedly move the locking member 120 into the allowing position 120B.

The pressing projection P may press a portion of the fastener 122 of the locking member 120 through the pressing hole 19, the portion being exposed to the outside through the pressing hole 19.

The fastener 122 placed in the first position 122A may be pressed by the pressing projection P to be rotated around the rotation portion 121 into the second position 122B. Accordingly, the locking member 120 placed in the restricting position 120A may be placed in the allowing position 120B, and the latch 30 may be changed from the locked state 30L to the unlocked state 30U.

Hence, the door 20 may be put into the movable state from the close position 20B to the open state 20A, and the user may be able to arbitrarily open the door 20.

Several embodiments of the disclosure have been described above, but a person of ordinary skill in the art will understand and appreciate that various modifications can be made without departing from the scope of the disclosure. Thus, it will be apparent to those of ordinary skill in the art that the true scope of technical protection is only defined by the following claims.

1. A cooking appliance comprising:
a cabinet including a cooking chamber and a pressing hole;
a door including a latch, the door being moveable between a close position in which the cooking chamber is closed and an open position in which the cooking chamber is opened; and
a locker inside the cabinet and including a locking member,
wherein the door and the locker are configured so that, in response to the door being moved to the close position,
the latch is inserted in the locker, and
with the latch inserted in the locker, the locking member is moveable between:
a restricting position where the latch is fastened to the locker so that movement of the latch out of the locker is restricted and the door is fastened to the cabinet in a locked state, and
an allowing position where the latch is unfastened from the the locker so that movement of the latch out of the locker is allowed and the door is unfastened from the cabinet in an unlocked state, and
the pressing hole is configured so that, with the locking member in the restricting position, an external force generated from outside of the cabinet is transferable through the pressing hole to the locking member to move the locking member to the allowing position.

2. The cooking appliance of claim 1, wherein with the door in the close position, the latch inserted in the locker, and the locking member in the restricting position, the locking member is rotatable between the restricting position and the allowing position.

3. The cooking appliance of claim 1, wherein with the door in the close position, the latch inserted in the locker, and the locking member in the restricting position, the locking member is moveable from the restricting position to the allowing position by the locking member being pressed by an external object inserted in the pressing hole.

4. The cooking appliance of claim 1, wherein
the locker further includes:
a pressing member, and
the locking member and the pressing member are configured so that, with the door in the close position, the latch inserted in the locker, and the locking member in the restricting position, the external force is transferable by the pressing member to move the locking member from the restricting position to the allowing position.

5. The cooking appliance of claim 4, wherein with the door in the close position, the latch inserted in the locker, and the locking member in the restricting position, the pressing member is pressable by an external object being inserted in the pressing hole so as to move the pressing member and thereby press the locking member to move the locking member from the restricting position to the allowing position.

6. The cooking appliance of claim 4, wherein the pressing member is between the pressing hole and the locking member.

7. The cooking appliance of claim 2, wherein
the locker further includes a driving motor, and
with the door in the close position and the latch inserted in the locker, the driving motor is configured to rotate the locking member between the restricting position and the allowing position.

8. The cooking appliance of claim 7, wherein
the locking member includes:
a rotator connected to the driving motor and configured to rotate with rotation of the driving motor, and
a fastener extending from the rotator and configured to rotate with rotation of the rotator so that, with the door in the close position and with the latch inserted in the locker, in response to the locking member being rotated to the restricting position by the driving motor, the latch is fastened to the locker by the fastener.

9. The cooking appliance of claim 8, wherein with the door in the close position, the latch inserted in the locker, and the locking member in the restricting position, the fastener is adjacent to the latch so that movement of the latch out of the locker is restricted.

10. The cooking appliance of claim 9, wherein
with the door in the close position and with the latch inserted in the locker,
in response to the locking member being rotated from the restricting position to the allowing position, the fastener is moved away from the latch so that movement of the latch out of the locker is allowed.

11. The cooking appliance of claim 9, wherein:
the locker further includes a guide configured so that, in response to the latch being inserted in the locker, and a fixer arranged for the latch to be fixed to the locker, and
with the door in the close position, the latch inserted in the locker, and the locking member in the restricting position, the fastener is above the latch.

12. The cooking appliance of claim 5, wherein the pressing member is configured to move by rotation to press the locking member.

13. The cooking appliance of claim 12, wherein
with the door in the close position, the latch inserted in the locker, and the locking member in the restricting position,
the locking member is rotatable between the restricting position and the allowing position, and
the locking member is rotatable to the allowing position by the locking member being pressed in a pressing direction of the pressing member.

14. The cooking appliance of claim 13, wherein an extending direction of an axis of rotation of the locking member is parallel to an extending direction of an axis of rotation of the pressing member.

15. The cooking appliance of claim 13, wherein
with the door in the close position and the latch inserted in the locker, a direction in which the locking member is rotated from the restricting position to the allowing position corresponds to a direction in which the locking member is rotated by the external force transferred through the pressing hole.
